(19) United States
(12) Patent Application Publication
(10) Pub. No.: US 2007/0076044 A1
(43) Pub. Date: Apr. 5, 2007

(54) Removable sealing tape with thin adhesive

(75) Inventors: Richard E. Corley JR., Lexington, KY (US); Brian C. Hart, Georgetown, KY (US); James M. Mrvos, Lexington, KY (US); Paul T. Spivey, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/241,218

(22) Filed: Sep. 30, 2005

(51) Int. Cl. B41J 2/165

(52) U.S. Cl. 347/29

(57) ABSTRACT

Sealing tapes, such as those utilizing an ultra-thin adhesive layer for attaching the sealing tape to the nozzle member of an ink jet printhead. One such ultra-thin adhesive has a thickness of 3 microns or less, and can be applied using pressure or both heat and pressure.

### FIELD OF THE INVENTION

This invention relates to a sealing tape for sealing ink jet printhead nozzles utilizing a very thin adhesive.

### BACKGROUND AND SUMMARY OF THE INVENTION

Ink jet printheads for use in printer applications are generally filled with ink shortly after manufacture but prior to shipping. In order to facilitate packaging and shipping, a removable seal for the ink jet nozzles (e.g., holes) is required which prevents the ink from leaking during packaging and shipping but is easily removable by the end user. Due to its relatively low cost and relative ease of use, standard tapes or films have been used for this application.

In addition to being required to form a fluid seal for the nozzles which will prevent leaking during packaging and shipping, a sealing material which does not leave portions of the tape adhered to the printhead nozzle member (e.g., a nozzle plate) or adhesive residue on the nozzle member or in the nozzle itself when the tape is removed by the end user prior to use is desired. In recent years, the difficulty of meeting these requirements has increased by the smaller size of nozzles found on newer printheads as well as by the fact that end users may not always remove the seal in the manner prescribed in the directions. While meeting these requirements, the sealing material must also be formulated so that it adheres well enough to maintain a tight seal throughout a variety of shipping and storage conditions to prevent leakage issues and that is materially compatible and is not degraded by the ink contained in the cartridge. Presently significant time and money are lost due to re-taping of printheads that leak after initial sealing. In many instances, a re-taping is not even possible requiring that the entire printhead be discarded.

Prior art sealing devices have consisted of sealing tapes utilizing relatively thick adhesive layers that are pressed or forced against the nozzles resulting in a seal. While generally adequate to seal the ink cartridges, in some instances the thickness of these adhesive tapes results in an adhesive layer of the tape being left on the head resulting in undesirable nozzle clogs. Other prior art methods for sealing ink jet printhead cartridges include the use of a thin thermoplastic polymer film in a manner as described in U.S. Pat. No. 6,634,732. As is described in that patent, as an alternative to the use of an adhesive, a thermoplastic polymer film may be used. However, even the film described in that patent is not as thin as may be desired to eliminate all of the problems associated with prior art adhesives. Furthermore, the use of a film only, and not a PSA, requires a relatively complex, time consuming, and expensive operation to properly apply the seal to the ink jet cartridge.

Accordingly, what is needed is, for example, a sealing tape that seals the nozzles sufficiently to prevent leakage during packaging and shipping, which may be simply and easily applied to a nozzle member, and which may be simply and easily removed by an end user without leaving remains of the tape or adhesive residue on the nozzle member or in the nozzles.

Embodiments of the present invention can provide a sealing tape utilizing an ultra-thin adhesive layer for attaching the sealing tape to the nozzle member of, for example, an ink jet printhead. The ultra-thin adhesive layer should effectively seal the nozzles to prevent leakage during packaging and shipping. The use of an ultra-thin adhesive layer should also limit the volume of adhesive material that can flow into nozzles and the concomitant problems with clogs that may be caused thereby. Such a sealing tape can be applied using pressure or both heat and pressure (such as by known heat-staking methods). The melting point of the adhesive (and backer) in accordance with an exemplary embodiment is to be above 60° C., so the adhesive will not melt or lose integrity and flow into the nozzles during shipping or storage. A backer provides support for the adhesive and, in an exemplary embodiment, contributes to forming the fluidic seal over the nozzles of the nozzle member. The backer material may be comprised of a PVC film or any number of other suitable materials well known in the art such as polyester, polypropylene, or polyurethane.

### BRIEF DESCRIPTION OF THE DRAWINGS

FIG. 1 shows a cross-sectional view of a sealing tape in accordance with an exemplary embodiment of the present invention;

FIG. 2 shows a cross-sectional view of an alternate embodiment of a sealing tape in accordance with an embodiment of the present invention; and

FIG. 3 shows a cross-sectional view of an alternate embodiment of a sealing tape in accordance with an embodiment of the present invention.

### DETAILED DESCRIPTION

The present invention provides, in one embodiment, a sealing tape utilizing an ultra-thin adhesive that is operable to effectively seal ink jet nozzles without losing structural integrity during packaging or shipping. Additionally, the sealing tape may be easily removed by an end user without leaving undesirable portions of the tape or sealing material residue which might clog or otherwise foul the nozzles.

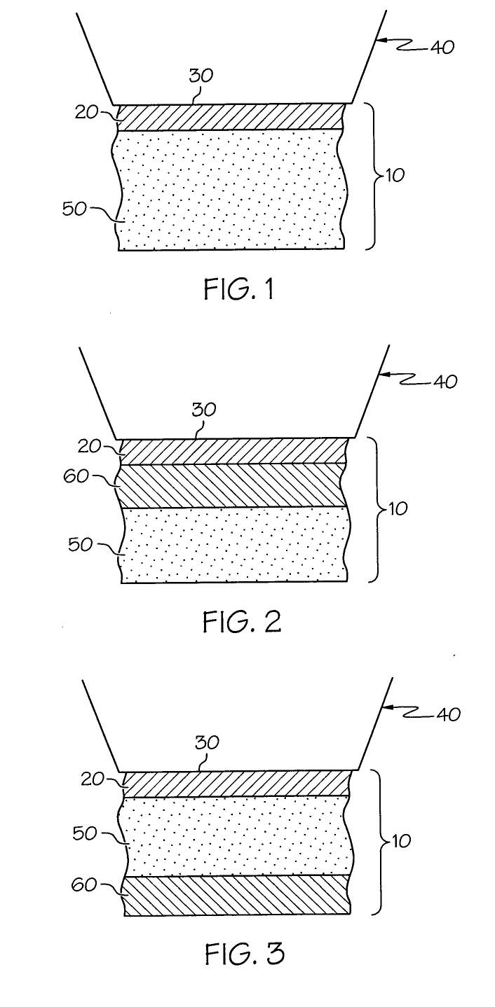

As shown in FIG. 1, an exemplary embodiment includes a sealing tape 10 utilizing an ultra-thin adhesive layer 20 for attaching the sealing tape 10 to the nozzle member (e.g., plate 30) of an ink jet printhead 40. The ultra-thin adhesive layer 20 should effectively seal the nozzles (not shown) to prevent leakage during packaging and shipping. The use of an ultra-thin adhesive layer 20 should also limit the volume of adhesive material that can flow into nozzles and the concomitant problems with clogs that may be caused thereby. The sealing tape 10 utilizing an ultra-thin adhesive 20 can be applied using pressure or both heat and pressure (such as by known heat-staking methods). The backer 50 provides support for the adhesive layer 20 and, in an exemplary embodiment, contributes to forming the fluidic seal over the nozzles of the nozzle plate 30. The backer 50 may be comprised of a PVC film or any number of other suitable materials well known in the art such as polyester, polypropylene, or polyurethane. In an exemplary embodiment, the melting point of the adhesive 20 (and backer 50) is to be above 60° C., so the adhesive and the backer will not melt or lose integrity and flow into the nozzles during shipping or storage of the printhead.

The ultra-thin adhesive 20 may be applied to the backer 50 at a thickness from 3 microns to less than 1 micron. The adhesive 20 may consist of any desired adhesive as is known in the art and may include generally known PSA's as well as other known adhesives. In particular, the adhesive 20 can be one that is not degraded by the ink that is stored in the cartridge. Representative, but non-limiting, examples of operable adhesives include conventional PSA's as well as thermoplastic adhesives. More specifically, such materials may include acrylate-based PSA's, rubber-based PSA's, amorphous polyesters, ethylene-vinyl acetate copolymers (EVA's), ethylene-vinyl acetate-methacrylate acid terpolymers (commercially available from E.I. DuPont de Nemours & Co. under the trademark ELVAX.RTM. 4260), ethylene-methacrylic acid copolymers partially neutralized by metal ions (commercially available from E.I. DuPont de Nemours & Co. under the trademark SURLYN.RTM. 1601), ethylene-glycidyl methacrylate based copolymers (commercially available from Atofina Chemicals Inc. under the trademark LOTADER.RTM. 884), ethylene vinyl acetate copolymers (commercially available from Exxon Mobil Chemical under the trademark ESCORENE), and n-Butyl Acrylate copolymers (commercially available from Exxon Mobil Chemical under the trademark ENABLE).

The nozzle plate 30 may include one or more nozzles (not shown) through which ink is released. The nozzle plate 30 may be formed of metal, polymer, glass, or other suitable materials such as ceramics. In an exemplary embodiment, the nozzle plate 30 is formed from a polymer such as polyimide, polyester, polyethylene naphthalate (PEN), epoxy, or polycarbonate. Examples of commercially available nozzle plate 30 materials include a polyimide film available from E.I. DuPont de Nemours & Co. under the trademark “Kapton”, a polyimide material available from Ube Industries, LTD (of Japan) under the trademark “Upilex”, and a photoimagible epoxy available from MicroChem Corp. under the trademark NANO SU-8. In an alternate embodiment, the nozzle plate 30 is formed from a metal such as a nickel base enclosed by a thin gold, palladium, tantalum, or rhodium layer.

The sealing tape 10 may be initially provided on a roll, cut to the appropriate length, and aligned with the nozzle plate 30 such that the sealing tape 10 fully covers the nozzles. The tape 10 may then be pressed onto the nozzle plate 30 either using simple pressure or using a heated platen (not shown) when the heat staking method is used.

The sealing tape 10 may be conventionally made in a two-layer construction where the ultra-thin adhesive 20 is coated onto the backer 50 in the desired ultra-thin thickness as is conventionally know in the art. Although the thickness of the backer 50 may be any thickness as desired and may vary depending on the application, the thickness of the backer 50 in an exemplary embodiment ranges from about 5 to about 500 microns, such as from about 5 to about 50 microns thick and, in an exemplary embodiment, from about 10 to about 25 microns thick. In an illustrative embodiment, the backer 50 can have a melting point that is higher than that of the ultra-thin adhesive 20. The ultra-thin adhesive 20 may be any thickness below about 4 microns in thickness, such as between 3 microns and about 1 micron in thickness. The adhesion between the backer 50 and the ultra-thin adhesive layer 20 can be adjusted as desired for a particular application, such as by any method known in the art. In particular, the adhesion can be adjusted by pretreating the backer before coating the ultra-thin adhesive thereon using known plasma treating or corona discharge treating methods. Alternatively, known surface treating methods, including laser, flame, chemical, or by use of a separate coupling coating, may also be utilized and are within the scope of the invention.

In an alternate embodiment, a three layer construction utilizing a separate moisture barrier film 60 bonded to the backer 50 is provided. In this embodiment, the ultra-thin adhesive layer 20 may be coated onto either the moisture barrier film 60 (as shown in FIG. 2) or to the backer 50 (as shown in FIG. 3) either before or after the moisture barrier film 60 is bonded to the backer 50. The moisture barrier film 60 may be any well known material suitable to prevent the passage of moisture therethrough and includes polyethylene, however, other materials can be utilized such as liquid crystal polymers, and even a metal or inorganic layer can be used. Although the thickness of the moisture barrier layer 60 will depend both on the particular application, the thickness in an exemplary embodiment ranges from about 0.01 to about 25 microns, such as from about 0.5 to about 15 microns. Although the total thickness of the sealing tape 10 will depend on the application and whether a moisture barrier film 60 is utilized, the total thickness in an exemplary embodiment is in the range of from about 20 to about 150 microns, such as in the range from about 25 to about 100 microns in thickness, and, in an illustrative embodiment, is in the range from about 25 to about 75 microns.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A sealing tape for sealing a nozzle associated with a printing apparatus: comprising:
an ultra-thin adhesive having a thickness of 3 microns or less; and
a backer providing a carrier for said adhesive.

2. The sealing tape of claim 1 wherein said ultra-thin adhesive is a PSA.

3. The sealing tape of claim 1 wherein said ultra-thin adhesive is a thermoplastic polymer.

4. The sealing tape of claim 1 wherein said thickness of said ultra-thin adhesive is about 2 microns or less.

5. The sealing tape of claim 1 wherein said thickness of said ultra-thin adhesive is about 1 micron or less.

6. The sealing tape of claim 1 wherein said ultra-thin adhesive has a melting point above about 60° C.

7. The sealing tape of claim 1 wherein said backer has a melting point above about 60° C.

8. The sealing tape of claim 1 wherein said backer is a thermoset or cross-linked polymer.

9. The sealing tape of claim 1 further comprising a moisture barrier film between said backer and said adhesive.

10. The sealing tape of claim 1 further comprising a moisture barrier film on the side of said backer opposite said adhesive.

11. A process for sealing a nozzle associated with a printing apparatus with a sealing tape comprising an ultra-thin adhesive having a thickness of 3 microns or less applied to a backer, comprising applying said sealing tape to a nozzle member having nozzles therein so as to form a fluidic seal over said nozzles.

12. The process of claim 11 wherein said applying act includes using pressure to apply said sealing tape to said nozzle member.

13. The process of claim 11 wherein said applying act includes using pressure and heat to apply said sealing tape to said nozzle member.

14. The process of claim 13 wherein said using of heat to apply said sealing tape includes heating said adhesive above its glass transition temperature but below its melting point.

15. The process of claim 11 wherein said thickness of said ultra-thin adhesive is about 2 microns or less.

16. The process of claim 11 wherein said thickness of said ultra-thin adhesive is about 1 micron or less.

17. An inkjet printhead cartridge comprising:
an ink reservoir;
a nozzle member having nozzles therein for allowing ink transfer from said ink reservoir; and
a sealing tape attached to said nozzle member forming a fluidic seal for said nozzles, said sealing tape comprising an ultra-thin adhesive having a thickness of 3 microns or less and a backer providing a carrier for said adhesive.

18. The inkjet printhead cartridge of claim 17 wherein said ultra-thin adhesive is a PSA.

19. The inkjet printhead cartridge of claim 17 wherein said ultra-thin adhesive is a thermoplastic polymer.

20. The inkjet printhead cartridge of claim 17 wherein said thickness of said ultra-thin adhesive is about 2 microns or less, said ultra-thin adhesive has a melting point above about 60° C., said backer has a melting point above about 60° C., and said backer is a thermoset or cross-linked polymer.
